(19) United States
(12) Patent Application Publication
(10) Pub. No.: US 2017/0303736 A1
(43) Pub. Date: Oct. 26, 2017

(54) Reservoir Refill System

(71) Applicant: John Eccker, Ashland, PA (US)

(72) Inventor: John Eccker, Ashland, PA (US)

(21) Appl. No.: 15/492,031

(22) Filed: Apr. 20, 2017

Related U.S. Application Data
(60) Provisional application No. 62/325,518, filed on Apr. 21, 2016.

(51) Int. Cl. A47J 31/56; A47J 31/46

(52) U.S. Cl. CPC A47J 31/56; A47J 31/46

(57) ABSTRACT

A system for refilling the water reservoir of an appliance (such as found in a coffee maker, humidifier, etc.) takes the form of a fixture that receives a water line inlet tubing at its input (the tubing coupled to an existing water line). The fixture also includes outlet tubing, which is coupled to the reservoir of the appliance. Also included within the fixture is a shut-off valve that is used to control the flow from the inlet tubing to the outlet tubing. Thus, a user is able to control the flow of water to the reservoir in a manner where it is possible to quickly and easily refill the reservoir without removing the reservoir itself, or needing to transport water from a faucet to the appliance.

### CROSS-REFERENCE TO RELATED APPLICATIONS

This application claims the benefit of U.S. Provisional Application Ser. No. 62/325,518, filed Apr. 21, 2016 and herein incorporated by reference.

### TECHNICAL FIELD

The present invention relates to a reservoir refill configuration for use in apparatus that require a water supply.

### BACKGROUND OF THE INVENTION

Many small appliances, such coffee makers and humidifiers include some sort of holding tank or reservoir system to supply the water required in their use. For appliances such as these, it is not practical (or even possible at times) to install typical water fixtures at their location to allow local filling. Their reservoirs must be removed from the appliance and filled at another source (such as a sink). Alternatively, a separate container is filled at the sink and transports to the water to the appliance, filling the reservoir where it is located.

In either case, there may be occasions where the water is spilled and/or the reservoir is filled to overflowing. In other circumstances, one may try to ignore the lower water level and attempt to use the appliance, only to receive a ‘warning light’ indication that there is insufficient water present in the reservoir tank.

### SUMMARY OF THE INVENTION

The problems remaining in the prior art are addressed by the present invention, which relates to a reservoir fill configuration for such appliances that include a reservoir or any type of water-holding tank.

In accordance with one or more aspects of the present invention, a fill control system is coupled between an appliance reservoir and a water source (for example, input line to a kitchen sink, refrigerator, or other incoming water supply line location).

One exemplary embodiment of the present invention takes the form of a refill system for a brewing apparatus reservoir comprising a filling fixture coupled between an incoming water supply line and the brewing apparatus reservoir. The filling fixture itself includes inlet tubing having a first end termination and a second, opposing end termination (the first end termination coupled to the incoming water supply line), outlet tubing having a first end termination and a second, opposing end termination (the first end termination coupled to the brewing apparatus reservoir), and a shut-off valve coupled between the second end terminations of the inlet tubing and the outlet tubing. The position of the shut-off valve is used to control the connection between the incoming water supply line and the brewing apparatus reservoir, providing a refill of the reservoir as controlled by the user.

Other and further embodiments and examples of the present invention will become apparent during the course of the following discussion and by reference to the accompanying drawings.

### BRIEF DESCRIPTION OF THE DRAWINGS

Referring now to the drawings, where like numerals represent like parts in several views:

FIG. 1 is a simplified diagram illustrating a prior art coffee brewer;

FIG. 2 illustrates an exemplary continuous-fill system formed in accordance with the present invention;

FIG. 3 illustrates the embodiment of FIG. 2, with a continuous-fill fixture attached to the underside of a cabinet;

FIG. 4 is a view from the rear of an exemplary brewing system, clearly showing the attachment of inlet and outlet tubing to the inventive continuous-fill fixture; and

FIG. 5 is a view of an exemplary fill fixture of the present invention, showing a valve in place within the fill fixture.

### DETAILED DESCRIPTION

The present invention overcomes all of these difficulties in the form of a continuous-fill system that is inserted between a water line (already existing at that location) and the reservoir portion of an appliance (for example, a coffee maker, humidifier, or the like). The continuous-fill system includes a valve controlled by the user so that he/she is able to control when water is added to the reservoir. The following discussion and accompanying drawings illustrate the principles of the present invention.

FIG. 1 is a simplified diagram illustrating a prior art coffee brewer. While for the sake of discussion a single-cup brewing system is described, it is to be understood that the continuous-fill system of the present invention may also be used with any type of appliance (for example, a humidifier) which includes a water reservoir.

In particular, FIG. 1 is a side view of an exemplary single-cup coffee maker 1, which includes a basket 2 within which a serving cup or pod of coffee is introduced. A coffee cup (not shown) is placed upon platform 3, which is located directly beneath basket 2. Also shown in FIG. 1 is a reservoir 4 that is used to hold a given amount of water (say, enough for 2 or 3 cups of coffee). A brewing system 5 includes the necessary electronics utilized to heat the water, and includes an inlet port 6 that allows the water in reservoir 2 to enter brewing system 5. The water is heated as it passes through brewing system 5, and then exits system 5 at outlet port 7, where it is introduced to basket 2 to initiate brewing. Although not shown in this diagram, brewing system 5 includes various elements that control the amount of liquid that pass through the system in each instance of brewing a cup of coffee.

As discussed above, one limitation with this type of prior art coffee maker is that reservoir needs to be refilled relatively often. While in most cases the reservoir is completely removable (so that it can be transported to a faucet for refilling), it is sometimes a cumbersome task.

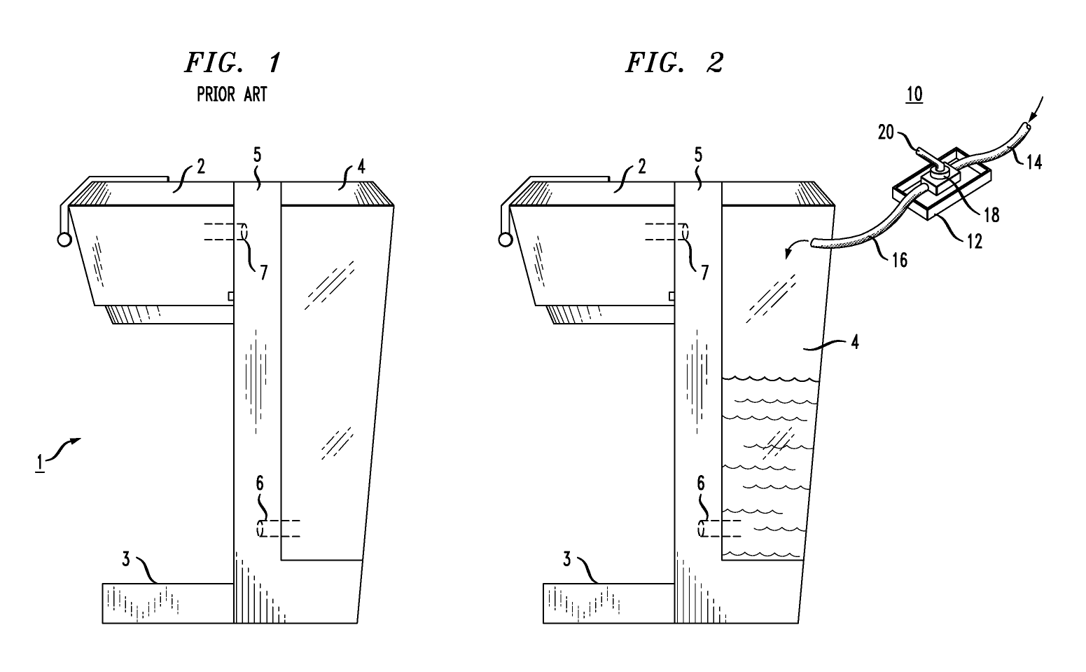

FIG. 2 illustrates an exemplary continuous-fill system 10 formed in accordance with the present invention. In the particular example as shown in FIG. 2, system 10 is shown as used in conjunction with a conventional brewing apparatus (here, a coffee maker) to provide for the ability of the user to simply turn a valve located in proximity of the coffee maker to refill the reservoir. It is to be understood, however, that the continuous-fill system of the present invention may be used with any type of appliance or system that includes a water reservoir, such as a humidifier, pet drinking source, or the like.

Looking at the particular configuration as shown in FIG. 2, continuous-fill system 10 comprises a fixture 12 that receives at its input a water line inlet tubing 14. Inlet tubing 14 is coupled to an existing water line in the kitchen (such as near a faucet, refrigerator water line, or the like). Fixture 12 also includes an outlet tubing 16, which exits fixture 12 and is coupled to reservoir 4 in the manner shown. In accordance with the present invention, outlet tubing 16 may be coupled to reservoir 4 in any suitable fashion, such as through a hole made in a lid portion of reservoir 4, through a hole made in an upper location of a wall of the reservoir, etc.

Also included within fixture 12 is a shut-off valve 18 that is used to control the flow from inlet tubing 14 to outlet tubing 16. A valve controller 20 is attached to valve 18, allowing the user to control the flow of water to reservoir 4. In accordance with the present invention, therefore, it is possible to quickly and easily refill the coffee maker reservoir without removing the reservoir itself, or needing to transport water from a faucet to the coffee maker.

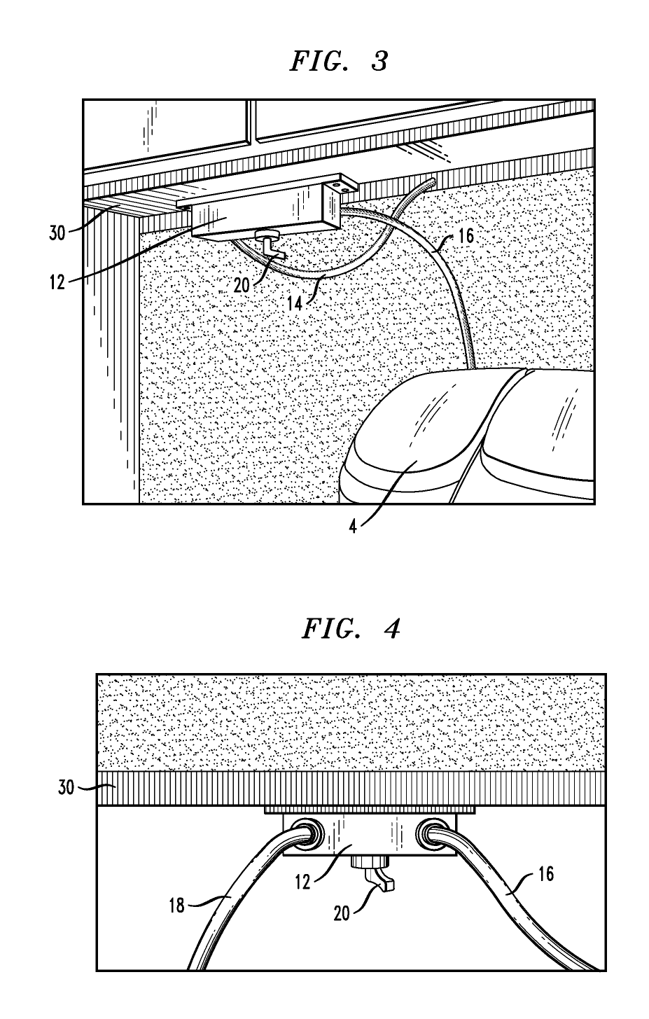

In one exemplary embodiment, continuous-fill system 10 may be attached to an underside of a cabinet in close proximity to the associated appliance reservoir. FIG. 3 illustrates this particular configuration, where fixture 12 is shown as attached to the underside of a cabinet 30. Outlet tubing 16 is clearly shown as exiting fixture 12 and being coupled to a reservoir 4 of the coffee maker. Inlet tubing 14 is also shown (and may originate from a water intake for a refrigerator, faucet or the like). In this case, inlet tubing 14 exits the room through a hole drilled in the wall under cabinet 30, and thereafter into an adjacent utility room (not shown in this view), where it is attached to an existing water supply line.

Valve controller 20 is shown in the arrangement of FIG. 3. As discussed above, the user operates continuous-fill system 10 by moving valve controller 20 between its “closed” and “open” position, allowing the water to flow from inlet tubing 14 to outlet tubing 16, filling reservoir 4. FIG. 4 is a view from the rear of system 10, clearly showing the attachment of inlet tubing 14 and outlet tubing 16 to fixture 12.

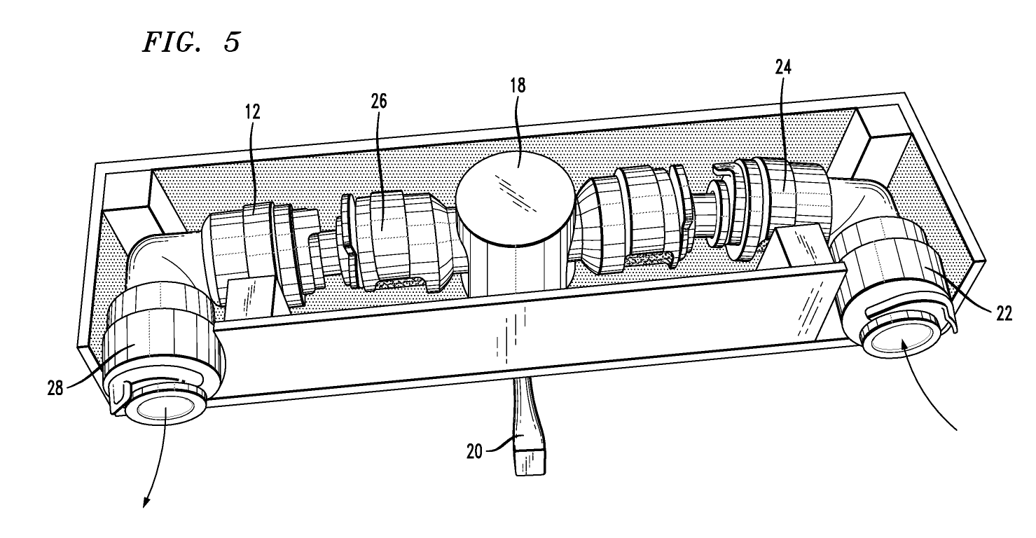

FIG. 5 is a view of an exemplary fixture 12, showing valve 18 in place within fixture 12. In this particular configuration, an inlet coupling 22 is used to provide the attachment to inlet tubing 14 (not shown). Once attached, the water entering fixture 12 at inlet coupling 22 passes through a first section of internal tubing 24 until it reaches valve 18. A second section of internal tubing 26 is also included in fixture 12, and is coupled to the outlet of valve 18. Second section 26 terminates at an outlet coupling 28, which is then attached to outlet hosing 16 (not shown). Valve controller 20 is also shown in this view, where it is evident that valve controller 20 is external to fixture 12, passing through the fixture housing and attached to valve 18. Thus, a user controls the “open” and “closed” position of valve 18 by the movement of valve controller 20.

It is to be understood that the particular configuration of components as shown and described is considered to be exemplary only. Indeed, various other arrangements of tubing and a valve may be used to provide the continuous-fill system of the present invention. For example, a configuration of the continuous-fill system may be housed within a utility box (similar in size and shape to an electrical outlet), with the input water line coming up inside the wall to into the bottom of the box (“up” from the basement, for example), and the output water line exiting through a front face of the box, and coupling into a water reservoir of an appliance (such as a humidifier). In this “box-shaped encasement” configuration, the continuous-fill apparatus of the present invention may be mounted in any easy-to-reach location near the appliance reservoir. The scope of the present invention is not intended to be limited by any of the above-described specific features and embodiments. Instead, the parameters of the present invention are considered to be limited only by the scope of the claims appended hereto.

What is claimed is:

1. A refill system for an appliance water reservoir, comprising
a filling fixture coupled between an incoming water supply line and the appliance water reservoir, the filling fixture comprising
inlet tubing having a first end termination and a second, opposing end termination, the first end termination coupled to the incoming water supply line;
outlet tubing having a first end termination and a second, opposing end termination, the first end termination coupled to the appliance water reservoir; and
a shut-off valve coupled between the second end terminations of the inlet tubing and the outlet tubing, wherein the position of the shut-off valve is used to control the connection between the incoming water supply line and the appliance water reservoir, providing a refill of the reservoir as controlled by the user.

2. The refill system as defined in claim 1 wherein the filling fixture further comprises a valve controller attached to the shut-off valve for use in controlling the position of the shut-off value.

3. The refill system as defined in claim 1 wherein the filling fixture comprises internal tubing coupled to the inlet tubing, outlet tubing, and shut-off valve.

4. The refill system as defined in claim 1 wherein the first end termination of the outlet tubing is disposed through a hole formed in the appliance water reservoir.

5. The refill system as defined in claim 1 wherein the fixture is configured to be housed within a box-shaped encasement installed in close proximity to the appliance water reservoir.

6. The refill system as defined in claim 1 where the appliance is a coffee maker.

7. The refill system as defined in claim 1 where the appliance is a humidifier.
